(19) United States
(12) Patent Application Publication
(10) Pub. No.: US 2022/0290306 A1
(43) Pub. Date: Sep. 15, 2022

(54) LASER METAL DEPOSITION SYSTEM

(71) Applicant: SAFRAN AIRCRAFT ENGINES, Paris (FR)

(72) Inventors: Sebastien Yohann POUZET, Moissy-Cramayel (FR); Herve Antoine Frederic SEINCE, Moissy-Cramayel (FR); Terence GRALL, Moissy-Cramayel (FR); Ronan MAUVOISIN, Moissy-Cramayel (FR)

(21) Appl. No.: 17/753,072

(22) PCT Filed: Aug. 17, 2020
(86) PCT No.: PCT/FR2020/051474

§ 371 Date: Feb. 17, 2022

(30) Foreign Application Priority Data
Aug. 22, 2019 (FR) FR1909356

(51) Int. Cl. C23C 24/10; B33Y 10/00; B33Y 30/00

(52) U.S. Cl. CPC C23C 24/106; B33Y 10/00; B33Y 30/00

(57) ABSTRACT

The invention relates to a laser metal deposition system, which comprises a feed nozzle (301), the tubular wall (306) of which has external fins (305) designed to allow heat dissipation by heat exchange with the immediate surroundings of the feed nozzle (301).

### TECHNICAL FIELD OF THE INVENTION

The invention relates to the field of the additive manufacturing of metal parts, in particular for aircrafts. In particular, the invention relates to a laser metal deposition system. The invention also relates to an additive manufacturing method implementing the laser metal deposition system.

### BACKGROUND

The prior art comprises in particular the documents GB-A-2 558 897, JP-A-2005 169396, U.S. Pat. No. 4,560,858 and CN-U-202 367 348.

The Direct Metal Deposition (DMD) is an additive manufacturing technique that allows the production of complex parts by depositing and stacking successive layers of a specific material. Among the many variations of this technique is the technique referred to as laser metal deposition (LMD) technique. To carry out a deposition, this technique implies regularly feeding a liquid bath of molten metal, located on the surface of a substrate, on which the deposition takes place. In particular, metal is brought to the liquid bath in the form of either a powder (referred to as LMD-powder) or a wire (referred to as LMD-wire), before being melted by a focused laser beam.

In the LMD-wire version, each laser metal deposition system comprises a system dedicated to the metal wire feeding that drives the wire to a feed nozzle. The role of this feed nozzle is then to guide the wire to the area of the deposition (i.e. to the liquid bath) where the wire is melted by a laser head. In addition, the guiding of the wire through the feed nozzle is performed in a conduit internal to said nozzle that is both wide enough to allow a good wire flow and narrow enough to guide the wire accurately.

However, depending on the part to be manufactured and to the quantity of material to be deposited, a deposition can be more or less long. Thus, in the case of a long deposit, the energy brought to the wire to melt it can lead to a significant temperature rise likely to impact the components of the deposition system. In particular, the high temperature of the molten metal can cause a deformation of the feed nozzle of the wire located nearby. Indeed, this feed nozzle (generally made of copper) tends to lengthen under the effect of heat. In addition, such an elongation leads to a narrowing of the conduit in which the wire is guided, which can hinder the proper circulation of the metal wire or even block it completely. In summary, the heating of the feed nozzle that occurs during a long deposition can lead to a complete stop of the deposition process.

An example of wire laser metal deposition system is described with reference to FIGS. 1 and 2.

The laser metal deposition system 101 comprises a delivery system 102 adapted to deliver metal wire to a feed nozzle 103. Specifically, the metal wire 107 is fed by the delivery system to an inlet orifice 109 of the feed nozzle 103. The metal wire 107 then flows through a conduit internal to the nozzle 110, which passes right through the nozzle connecting the inlet orifice 109 located at the end of the feed nozzle in contact with the delivery system to the outlet orifice 111 located at the other end of the nozzle.

As the metal wire 107 exits the feed nozzle 103 at the level of the outlet orifice 111, it is melted by a focused laser beam 105 that produces a sufficiently high energy at its focal point to melt the metal. In the example shown, the laser beam 105 is generated by a laser head 104 located on the perimeter of the delivery system 102. In addition, the laser beam 105, emitted by the laser head 104, circulates through the air, up to its focal point, all around the feed nozzle 103. Thus, the feed nozzle is conical in shape to minimally impede the flow of the laser beam.

Finally, the molten metal is deposited on the surface of the substrate 106. In the example shown in FIG. 1, the deposition takes the form of a bead 108 whose shape is derived from the direction of movement of the laser deposition system 101 symbolized by the arrow 112. Thus, as the system moves over the substrate, the molten metal deposited on the substrate solidifies again as it cools and forms the bead 108.

FIG. 2 illustrates more precisely the effect of the deformation of the feed nozzle 103 due to its heating. In particular, the left side of the figure represents a laser metal deposition system in which the feed nozzle 103a has not undergone any deformation, whereas the right side of the figure represents a same system in which the feed nozzle 103b has elongated, for example, under the effect of the temperature. As mentioned above, in the case of the deformed feed nozzle 103b, the internal conduit 110 has narrowed due to the elongation of the nozzle causing the metal wire to become trapped in the nozzle. Classically, the conduit of the nozzle and the metal wire have a circular cross-section and the diameter of the conduit is slightly larger (in the order of 10-15% when cold) than that of the wire. Thus, as the nozzle heats up, this diameter shrinks and may prevent the metal wire from flowing through the nozzle.

A solution to this problem can consist in circulating a cooled gas directly in contact with the feed nozzle to avoid its heating and thus its deformation. Typically, a device adapted to generate a jet of argon is brought as close as possible to the feed nozzle in order to cool it as efficiently as possible during its use. However, such a solution involves adding new components to the deposition system and requires the use of additional resources, to a greater or lesser extent, depending on the duration of the deposition.

### SUMMARY OF THE INVENTION

The present invention proposes to allow an efficient passive cooling of the feed nozzle of a laser metal deposition system involving simple and inexpensive modifications to the laser metal deposition system. In addition, the invention aims to avoid a significant deformation of the feed nozzle under the effect of heat so as to allow an uninterrupted use of the nozzle, even for long depositions.

To this end, according to a first aspect, the invention relates to a laser metal deposition system comprising a delivery system adapted to deliver a metal wire to an inlet orifice of a feed nozzle, a feed nozzle comprising a tubular wall defining a cylindrical conduit passing through the feed nozzle along a longitudinal axis, between, on the one hand, an inlet orifice and, on the other hand, an outlet orifice, and a laser head adapted to generate the melting of the metal at the level of the outlet orifice of the feed nozzle, said tubular wall of the feed nozzle being characterised in that it further comprises a plurality of external fins adapted to allow a heat dissipation by thermal exchange with the immediate surrounding of the feed nozzle.

Thus, this solution allows to achieve the above-mentioned objective. In particular, the cooling of the feed nozzle allows to ensure that the geometrical characteristics of the feed nozzle are maintained regardless of the duration of a metal deposition.

The laser deposition system according to the invention may comprise one or more of the following characteristics, taken alone or in combination with each other:
the external fins have an annular shape;
the diameter of the external annular fins decreases from the inlet orifice of the feed nozzle to the outlet orifice of the feed nozzle;
the external peripheries of the external fins are comprised in a substantially conical shape adapted to allow the circulation of a focused laser beam around the feed nozzle;
the external fins have a rectangular cross-section;
the feed nozzle is made of metal, preferably copper;
the number of external fins is less than or equal to six, preferably equal to six;
the external fins have a thickness along the longitudinal axis between 0.7 and 1.3 millimetres and/or the external fins are spaced apart along the longitudinal axis by a distance between 0.7 and 1.3 millimetres;
the tubular wall of the feed nozzle, in a determined segment, located in the extension of the outlet orifice, defines a conduit whose diameter is between 1.05 and 1.25 millimetres, preferably equal to 1.15 millimetres.

The invention also relates, according to a second aspect, to a method for additive manufacturing by laser metal deposition by means of a laser metal deposition system according to any of the characteristics of the first aspect.

### BRIEF DESCRIPTION OF FIGURES

The invention will be better understood and other details, characteristics and advantages of the present invention will become clearer from the following description made by way of non-limiting example and with reference to the attached drawings, in which:

FIG. 1 is a schematic representation of a laser metal deposition system according to the prior art;

FIG. 2 is a schematic representation of the effect of heating on a laser metal deposition system according to the prior art;

FIG. 3a is a schematic representation of an embodiment of a feed nozzle of a laser metal deposition system according to the invention; and,

FIG. 3b is a photograph of an embodiment of a feed nozzle of a laser metal deposition system according to the invention.

The elements having the same functions in the different embodiments have the same references in the figures.

### DETAILED DESCRIPTION OF THE INVENTION

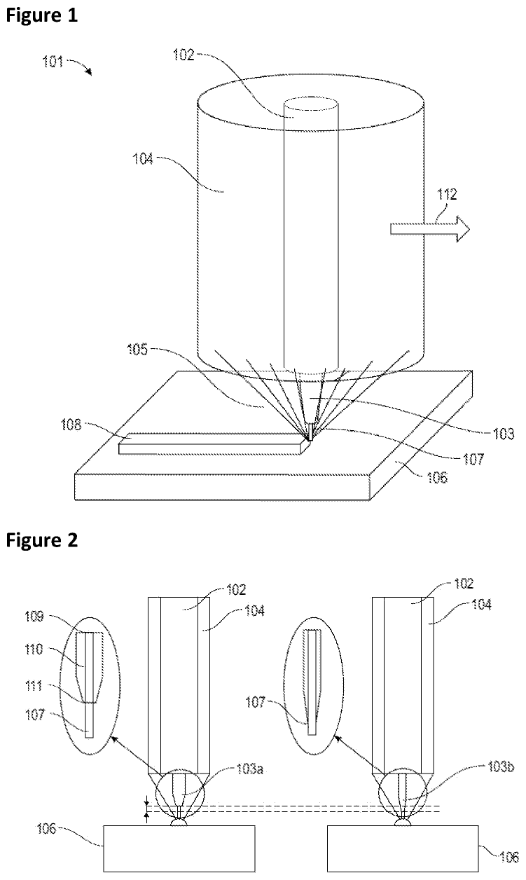

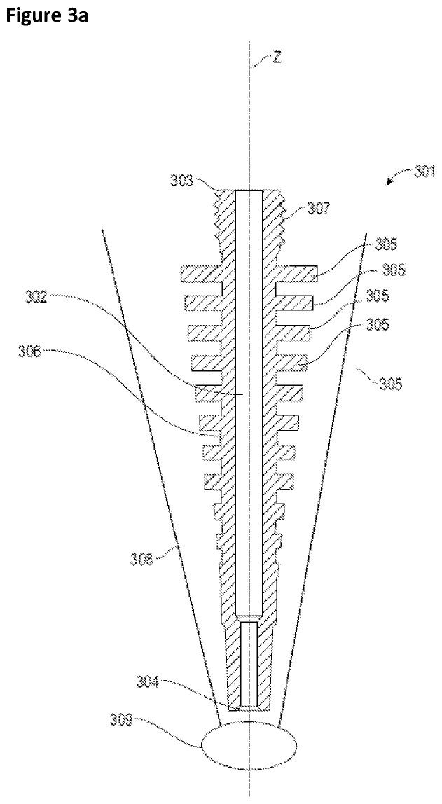

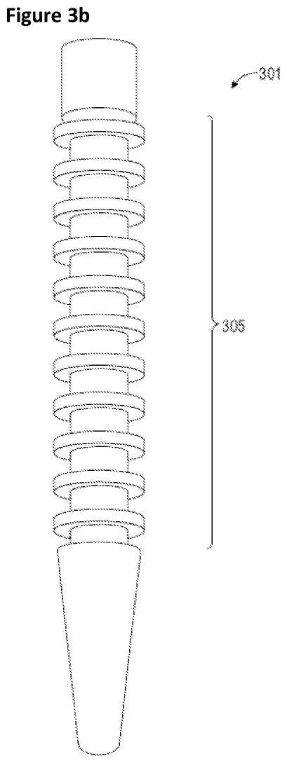

With reference to FIG. 3a and FIG. 3b, an embodiment of a feed nozzle of a laser metal deposition system according to the invention will now be described. The person skilled in the art will appreciate that, with the exception of the feed nozzle, all the other components of such a system conform to those of a system of the prior art such as that described with reference to FIGS. 1 and 2. In particular, in addition to the feed nozzle, the laser metal deposition system with which it is integrated comprises a delivery system adapted to supply a metal wire to the inlet orifice of the feed nozzle and a laser head adapted to generate the melting of the metal at the level of the outlet orifice of the feed nozzle.

In the illustrated example, the feed nozzle 301 comprises a tubular wall 306 that defines a cylindrical conduit 302 that passes through the nozzle along the longitudinal axis Z. The conduit extends from the inlet orifice 303 to the outlet orifice 304. The role of the conduit is to guide the metal wire. Thus, the inlet orifice 303 is in contact with the delivery system that supplies the metal wire and, after being guided through the feed nozzle 301, the metal wire exits at the level of the outlet orifice 304 to feed the liquid bath 309. The liquid bath 309 is thus fed by the metal (in the form of wire) melted by the focused laser beam 308.

Furthermore, in a particular embodiment, the tubular wall of the feed nozzle, in a determined segment, located in the extension of the outlet orifice, defines a conduit whose diameter is between 1.05 and 1.25 millimetres, preferably equal to 1.15 millimetres. Indeed, the metal wire is typically cylindrical with a diameter of 1 millimetre. The experience has shown that a conduit with a diameter of 1.15 millimetres allows the wire to be guided at the outlet of the nozzle with the greatest possible precision.

The feed nozzle 301 also comprises removable attachment means 307 such as, for example, an external thread allowing for screwing the nozzle into a complementary thread of a component of the deposition system. Advantageously, if the nozzle is damaged, it can be replaced without involving the replacement of another component of the laser metal deposition system.

In particular embodiments, the feed nozzle is made of metal, for example of copper. Advantageously, this material offers optimal strength and thermal conductivity properties for such use. In this way, some of the heat that may have accumulated in the feed nozzle can be dissipated by thermal exchange between the nozzle and its immediate surrounding, i.e., the air around it.

To increase the efficiency of these heat exchanges, the tubular wall of the feed nozzle 301 further comprises external fins 305 which are adapted to allow heat dissipation by thermal exchange with the immediate surrounding of said nozzle. The term “immediate surrounding” refers to the medium in direct contact with the external surface of the nozzle such as, for example, air, a gas or a liquid projected onto said nozzle. Indeed, as is well known, the efficiency of heat exchanges is linked to the surface of the material in direct contact with the surrounding in question. In other words, the presence of external fins on the wall of the nozzle increases the surface area of the nozzle in contact with its surrounding and, consequently, its ability to dissipate heat.

In one particular embodiment, the external fins have an annular shape. In addition, the diameter of these external annular fins may decrease from the inlet orifice of the feed nozzle to the outlet orifice of the feed nozzle. Finally, the external peripheries of the external fins may be comprised in a substantially conical shape adapted to allow, the circulation of a focused laser beam around the feed nozzle. Indeed, as illustrated in FIG. 3a, the focused laser beam 308 used to melt the metal itself has a substantially conical shape from the largest diameter at the level of the laser head (not shown) to the smallest diameter at the focal point (in the liquid bath 309). Therefore, this nozzle shape allows for the least possible obstruction of the laser flow around the nozzle.

In addition, the shape of the nozzle as well as the shape of the external fins may be a result of the manufacturing technique used to obtain the external fins. Advantageously, such a feed nozzle can be obtained by machining a feed nozzle according to the prior art. Thus, a feed nozzle according to the prior art, originally conical in shape, can be machined to create external fins on the tubular wall of the nozzle. Such a manufacturing technique limits the complexity and the cost associated with the manufacture of such a feed nozzle.

In addition, as in the example shown in FIG. 3a, the cross-section of the external annular fins may be rectangular. Advantageously, such a cross-sectional geometry limits the complexity of the machining process of the nozzle.

In another particular embodiment, the number of external fins is less than or equal to six, preferably six. This number of external fins allows both to optimize the efficiency of the heat exchanger and to limit the complexity of the manufacturing of the nozzle.

Furthermore, the person skilled in the art will know how to determine a minimum thickness that the tubular wall must have in order for the feed nozzle to maintain a certain rigidity. In other words, depending on the dimensions of the feed nozzle and the external fins, the tubular wall must be thick enough to prevent any mechanical deformation of the nozzle. In the example shown in FIGS. 3a and 3b, the minimum thickness of the wall is equal to 1 millimetre.

In particular embodiments, the external fins have a thickness along the longitudinal axis Z between 0.7 and 1.3 millimetres and/or are spaced apart along the longitudinal axis Z by a distance between 0.7 and 1.3 millimetres. This distance is the result of a compromise between the robustness of the nozzle, the efficiency of the heat exchanger and the complexity of manufacturing. In particular, the capacity of a fluid (liquid or gas) located in the immediate surrounding of the nozzle to circulate more or less well between the fins, impacts the performance of the heat exchanger they constitute.

Finally, the use of external fins to realize a heat exchanger allows to obtain, thanks to simple manufacturing techniques, an efficient passive cooling system. Furthermore, advantageously, such an approach can be combined with the use of a cooled gas to further increase the efficiency of the cooling of the nozzle and thus ensure that the laser metal deposition system can be used for long depositions without the risk of interruption of the deposition.

1. A laser metal deposition system comprising a delivery system adapted to deliver a metal wire to an inlet orifice of a feed nozzle, a feed nozzle comprising a tubular wall defining a cylindrical conduit passing through the feed nozzle along a longitudinal axis, between, on the one hand, an inlet orifice and, on the other hand, an outlet orifice, and a laser head adapted to generate the melting of the metal at the level of the outlet orifice of the feed nozzle,
said tubular wall of the feed nozzle being characterised in that it further comprises a plurality of external fins adapted to allow a heat dissipation by thermal exchange with the immediate surrounding of the feed nozzle.

2. The laser metal deposition system of claim 1, wherein the external fins have an annular shape.

3. The laser metal deposition system of claim 2, wherein the diameter of the external annular fins decreases from the inlet orifice of the feed nozzle to the outlet orifice of the feed nozzle.

4. The laser metal deposition system of claim 1, wherein the external peripheries of the external fins are comprised in a substantially conical shape adapted to allow the circulation of a focused laser beam around the feed nozzle.

5. The laser metal deposition system of claim 3, wherein the external fins have a rectangular cross-section.

6. The laser metal deposition system of claim 1, wherein the feed nozzle is made of metal, preferably copper.

7. The laser metal deposition system of claim 1, wherein the number of external fins is less than or equal to six, preferably equal to six.

8. The laser metal deposition system of claim 1, wherein the external fins have a thickness along the longitudinal axis between 0.7 and 1.3 millimetres and/or the external fins are spaced apart along the longitudinal axis by a distance between 0.7 and 1.3 millimetres.

9. The laser metal deposition system according to claim 1, wherein the tubular wall of the feed nozzle, in a determined segment, located in the extension of the outlet orifice, defines a conduit whose diameter is between 1.05 and 1.25 millimetres, preferably equal to 1.15 millimetres.

10. A method for additive manufacturing by laser metal deposition by means of a laser metal deposition system according to claim 1.
